(19) United States
(12) Patent Application Publication
(10) Pub. No.: US 2026/0340297 A1
(43) Pub. Date: Oct. 29, 2026

(54) AI-POWERED CONVERSATIONAL WORKFLOW WITH STRUCTURED CONTEXT MANAGEMENT AND HALLUCINATION PREVENTION

(71) Applicant: Trunknode Inc., Portland, OR (US)

(72) Inventors: Manan Goel, Portland, OR (US); Allonte Barakat, Portland, OR (US)

(21) Appl. No.: 19/188,892

(22) Filed: Apr. 24, 2025

(51) Int. Cl. G06F 40/35; G06F 40/40

(52) U.S. Cl. CPC G06F 40/35; G06F 40/40

(57) ABSTRACT

Methods and systems are provided for an AI-based conversational system that addresses limitations in current large language model (LLM) implementations, particularly focusing on preventing hallucinations while maintaining contextual awareness and response accuracy. The AI-based conversational system implements a structured workflow that enforces rigid conversational state management through defined nodes for conversation initiation, response generation, summarization, and memory retrieval, creating a controlled environment for AI responses. The state management system employs conditional logic that evaluates conversation context, user intent, and system resources to determine appropriate state transitions. This structured approach prevents the AI from deviating into uncontrolled response patterns by constraining possible pathways, significantly reducing the likelihood of hallucinations while ensuring conversations progress in a logically coherent manner.

### TECHNICAL FIELD

Embodiments of the subject matter disclosed herein relate to generative artificial intelligence (AI), and in particular, managing interactive conversations with large language models (LLMs).

### BACKGROUND

As organizations increasingly adopt artificial intelligence (AI) to drive decision-making and innovation, the demand for high-quality, structured data continues to rise. However, the AI industry faces significant challenges related to data scarcity, ethical and privacy concerns, and inefficiencies in accessing and managing datasets due to data fragmentation, lack of structure in data, and domain-specific limitations. Various content brokering platforms have emerged for acquiring customer data that address aspects of these problems. However, providing an integrated end-to-end solution for collecting, combining, preparing, and processing data from disparate sources for AI analysis typically entails a cumbersome and time-consuming process characterized by a large number of steps and decisions, which involve significant interaction with a platform user. For example, a data analyst may wish to collect specific types of data across a plurality of datasets available on a platform, which may be owned by different content owners and structured differently, where locating desired data across the plurality of datasets may be difficult. As a result, a user of the platform may become overwhelmed, and/or may not find the desired data without assistance. Providing customized manual assistance to users of the platform may be costly.

### SUMMARY

The current disclosure at least partially addresses one or more of the above identified issues by an artificial intelligence (AI)-based conversational system, comprising a processor; and a memory storing instructions that when executed, cause the processor to receive a text input from a user of the AI-based conversational system; enter into a state of the AI-based conversational system, based on the text input; retrieve a context of the text input from the memory; submit a prompt to a large language model (LLM), the prompt including the text input and the context; receive a response to the prompt from the LLM; perform a validation of the response, based on the state; in response to the validation being successful output the response to a display device and store the text input and the response in the context; and in response to the validation not being successful, prompt the user for clarification of the text input.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a block schematic diagram of an exemplary content brokering platform;

FIG. 2 shows a block schematic diagram of an exemplary AI-based conversational system of the content brokering platform;

FIG. 3 shows a block schematic diagram of a state graph representation of various states of operation of the AI-based conversational system;

FIG. 4 is a flowchart showing an exemplary high-level method for generating an interactive conversation with a user of the content brokering platform using the AI-based conversational system;

FIG. 5 is a flowchart showing an exemplary method for managing the interactive conversation using a large language model (LLM) of the AI-based conversational system;

FIG. 6 is a flowchart showing an exemplary method for generating a response to a query of the user using a first specialized AI agent of the AI-based conversational system;

FIG. 7 is a flowchart showing an exemplary method for generating a response to a query of the user via a second specialized agent of the one or more specialized AI agents;

FIG. 8 is a flowchart showing an exemplary method for validating a response of the AI-based conversational system; and

FIG. 9 is a flowchart showing an exemplary method for retrieving a previous context of the interactive conversation from a memory of the AI-based conversational system.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

An AI-based conversational system is disclosed that addresses limitations in current LLM implementations, particularly focusing on preventing hallucinations while maintaining contextual awareness and response accuracy. The AI-based conversational system is described in the context of a content brokering platform that provides content owned by a first group of content owners, to a second group of content licensors that wish to leverage data in the content to train AI models. Specifically, the AI-based conversational system is configured to provide automated assistance to users of the content brokering platform. The automated assistance may include answering questions about types of data included in available datasets, costs or pricing of data owned by different content owners and/or under different subscription models, policies or restrictions on using the data, and so on. The automated assistance may also include creating new datasets for the content licensors with data extracted from one or more of the available datasets of the provided content, and performing processing of the data in preparation for training an AI model. The automated assistance may be provided via an interactive conversation, or text chat, that is maintained between a user of the content brokering platform and the content brokering platform, via a graphical user interface (GUI) of the content brokering platform.

The AI-based conversational system employs several novel technical approaches that work in concert to achieve these goals. At its core, the AI-based conversational system implements a structured workflow, which enforces rigid conversational state management through defined nodes for conversation initiation, response generation, summarization, and memory retrieval, creating a controlled environment for AI responses. The state management system employs conditional logic that evaluates conversation context, user intent, and system resources to determine appropriate state transitions. This structured approach prevents the AI from deviating into uncontrolled response patterns by constraining possible pathways, significantly reducing the likelihood of hallucinations while ensuring conversations progress in a logically coherent manner.

Different workflows are identified and selected that are governed by logic that determines appropriate state transitions, ensuring that conversations progress logically while maintaining context. The AI-based conversation system implements a multi-agent collaboration architecture, where specialized AI components operate in a coordinated ecosystem. The architecture may employ a central orchestration layer that routes tasks to specialized agents optimized for summarization, information retrieval, inference generation, and/or other tasks. These agents may communicate through a standardized protocol that ensures consistent information exchange while maintaining system coherence. This modular approach increases an overall efficiency of the AI-based conversation system by allowing each agent to employ specialized algorithms for its specific function, while coordinating through a structured workflow.

An additional technical innovation is a hybrid AI model that dynamically switches between two operational modes: a complex multi-step workflow mode for tasks requiring sequential reasoning, and a context-sensitive interaction mode for direct conversational exchanges. The multi-step workflow may be implemented by a manager AI agent that relies on various other specialized AI agents to perform tasks at each step of the multi-step workflow. The context-sensitive interaction mode may be implemented by a memory aware agent that maintains a hierarchical index of conversation elements, including user queries, system responses, and identified entities, which may be selectively retrieved to provide context for prompts submitted to an LLM. The system may further rely on decision matrices, lookup tables, and/or statistical, probabilistic, machine learning (ML), or other types of models that evaluate query complexity, reasoning depth, and available contextual information to select a most suitable processing approach and pathway. This adaptive approach ensures computational resources are allocated efficiently based on conversational demands, improving both processing efficiency and response accuracy across diverse interaction scenarios.

Additionally, context management is facilitated via a summarization agent that performs an AI-driven conversation summarization. The summarization agent automatically summarizes chat history when a number of tokens exceeds threshold amounts. This technical implementation optimizes computational resource usage while preserving contextual relevance, allowing the system to maintain conversation coherence across extended interactions without exhausting memory or processing capacity.

Further, a hallucination prevention mechanism employs edge constraints that restrict the AI from generating responses outside defined pathways. These constraints are implemented through conditional edge validation routines that analyze potential responses against established knowledge parameters, factual databases, and conversation history before allowing transmission. The system may incorporate uncertainty quantification algorithms that flag potential hallucinations based on statistical confidence measures, effectively preventing the AI from making unfounded assertions or deviating from verified information.

To enhance contextual understanding, the system incorporates adaptive user intent recognition that continuously analyzes conversation patterns through semantic parsing, entity recognition, and discourse analysis. This technical subsystem may maintain a dynamic intent model that evolves throughout the conversation, detecting subtle shifts in user objectives and adjusting response strategies accordingly. The intent recognition system may employ classification tools and/or models that distinguish between informational queries, transactional requests, and conversational exchanges, preventing misaligned or irrelevant responses.

Additionally, the AI-based conversation system implements a reinforcement learning mechanism that captures and processes real-time user feedback signals. This technical feature employs a reward function that evaluates response relevance, accuracy, and user satisfaction indicators to generate model adjustment parameters. In some examples, the learning system may incorporate these parameters into a continuous optimization process that refines response generation algorithms without requiring model retraining, leading to increasingly accurate and relevant responses over time.

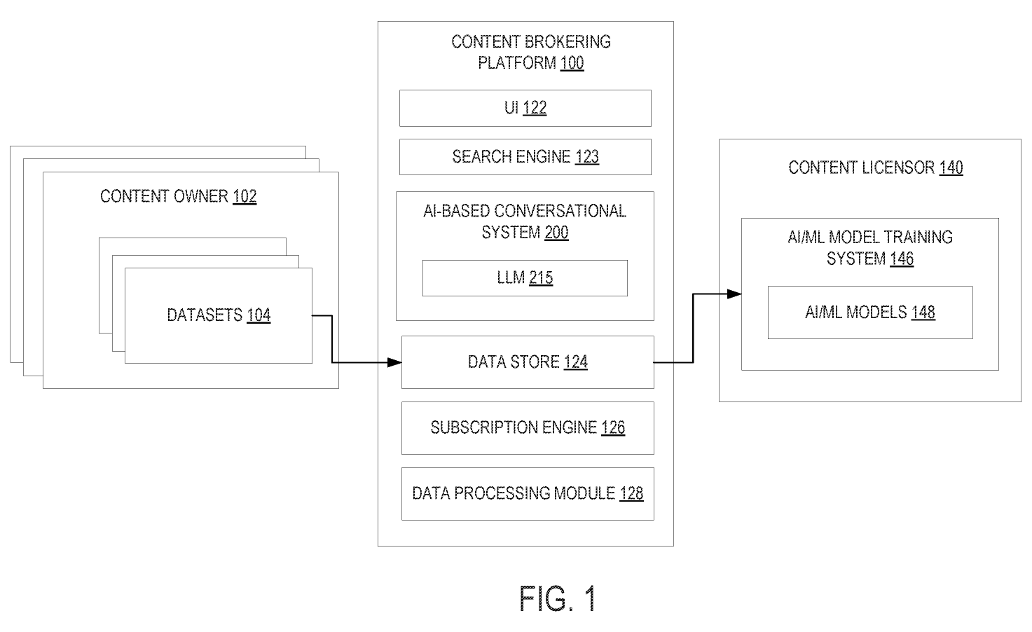

Turning now to the figures, FIG. 1 shows an exemplary content brokering platform 100, which may be used to provide data owned by a one or more content owners 102 to one or more of a content licensor 140, for training one or more AI/ML models 148. Each content owner 102 may have one or more datasets 104 including different data and/or types of data stored in one or more databases of the content owner 102. Each content owner 102 may wish to make the one or more datasets 104 available to content licensor 140 via a licensing agreement. Each content owner 102 may offer respective datasets 104 under different licensing terms. The AI/ML models 148 may include artificial neural network models of various types, including trained and/or untrained neural networks such as convolutional neural networks (CNNs), recurrent neural networks (RNNs), generative adversarial networks (GANs), or other types of neural networks; statistical models, or other models; LLMs; and may further include various data, or metadata pertaining to the one or more AI/ML models 148.

Content brokering platform 100 may include a user interface (UI) 122, a search engine 123, an AI-based conversational system 200, a data store 124, a subscription engine 126, and a data processing module 128. Content brokering platform 100 may make data stored in one or more datasets 104 of the content owners 102 accessible to content licensor 140, in accordance with a subscription managed by a subscription engine 126 of content brokering platform 100. A representative (e.g., analyst) of content licensor 140 may search the datasets 104 of various content owners 102 for desired data using search engine 123. Once the desired data is identified, the desired data may be uploaded to data store 124. The uploaded data may be processed by data processing module 128, if desired by the representative. Data processing module 128 may include AI-driven data processing capabilities that handle tasks such as automated data curation, tagging, and enrichment, transforming unstructured and fragmented data into AI-ready formats. Data processing module 128 may further incorporate data federation and observability features alongside automated data anonymization and de-identification systems, for example.

After the data is processed, the data may be transmitted from data store 124 to an AI/ML model training system 146 of content licensor 140. AI/ML model 148 may then be trained on the data within AI/ML model training system 146. In this way, data from a plurality of sources, made available under different licensing terms, may be combined and prepared for training by content brokering platform 100. Security for storing and transmitting the data may be provided with enterprise-grade encryption, advanced access control systems, AI-driven monitoring for anomaly detection, and comprehensive compliance controls for regulatory purposes.

In particular, AI-based conversational system 200 may complement search engine 123 to facilitate efficient location of the desired data, by offering contextual and semantic search capabilities via interactive conversation. AI-based conversational system 200 may include an LLM 215, which may generate responses to queries submitted by users of content brokering platform 100 via UI 122 regarding an availability of data within the datasets 104, processing tasks that may be performed on the data, costs and restrictions associated with the data, and/or other information. LLM 215 may also perform actions on the data based on instructions provided by the users via UI 122. For example, a user may instruct AI-based conversational system 200 to extract and combine data from various datasets 104 and create a new dataset including the extracted data. The user may also instruct AI-based conversational system 200 to preprocess the data of the new dataset for training AI/ML model 148 using data processing module 128, such as, for example, normalizing or standardizing data, removing outliers, etc.

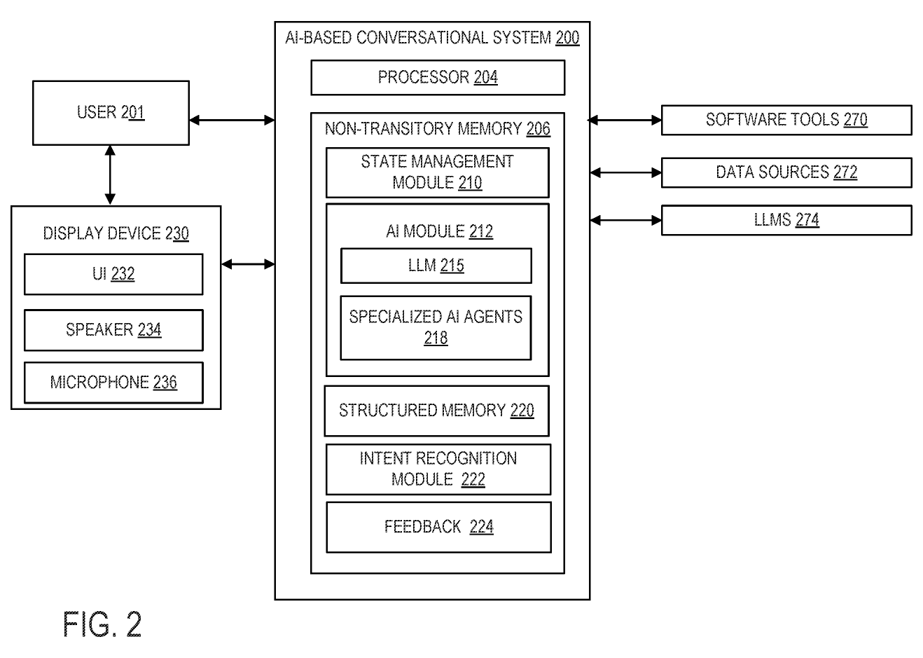

FIG. 2 shows components of the AI-based conversational system 200 of FIG. 1. AI-based conversational system 200 may be used by a user 201, who may be a representative of either a content owner 102 or a content licensor 140 of FIG. 1. User 201 may interact with AI-based conversational system 200 via a UI 232 displayed on a display device 230. In some examples, display device 230 may be a display device of content brokering platform 100 (e.g., a computer screen or display terminal). In other examples, display device 230 may be a computer device of user 201, such as a personal computer, laptop, tablet, smart phone, etc. UI 232 may be a non-limiting example of UI 122 of content brokering platform 100 of FIG. 1. UI 232 may be generated by content brokering platform 100 and/or AI-based conversational system 200 via a standalone application, a web browser, or similar technology.

Display device 230 may further include a speaker 234 and a microphone 236. In some examples, user 201 may interact with AI-based conversational system 200 verbally, where user 201 may submit queries or instructions to AI-based conversational system 200 via microphone 236, and receive audio output from AI-based conversational system 200 via speaker 234 in addition to or as an alternative to UI 232. While AI-based conversational system 200 is described herein as receiving text input from user 201 via UI 232, it should be appreciated that the text input may be generated from verbal input received via microphone 236, using technologies known in the art.

AI-based conversational system 200 includes a processor 204 and a non-transitory memory 206. Processor 204 may be configured to execute machine readable instructions stored in non-transitory memory 206. Processor 204 may be single core or multi-core, and the programs executed thereon may be configured for parallel or distributed processing. In some embodiments, processor 204 may optionally include individual components that are distributed throughout two or more devices, which may be remotely located and/or configured for coordinated processing. In some embodiments, one or more aspects of processor 204 may be virtualized and executed by remotely-accessible networked computing devices configured in a cloud computing configuration. In some embodiments, non-transitory memory 206 may include components disposed at two or more devices, which may be remotely located and/or configured for coordinated processing. In some embodiments, one or more aspects of the non-transitory memory 206 may include remotely-accessible networked storage devices configured in a cloud computing configuration.

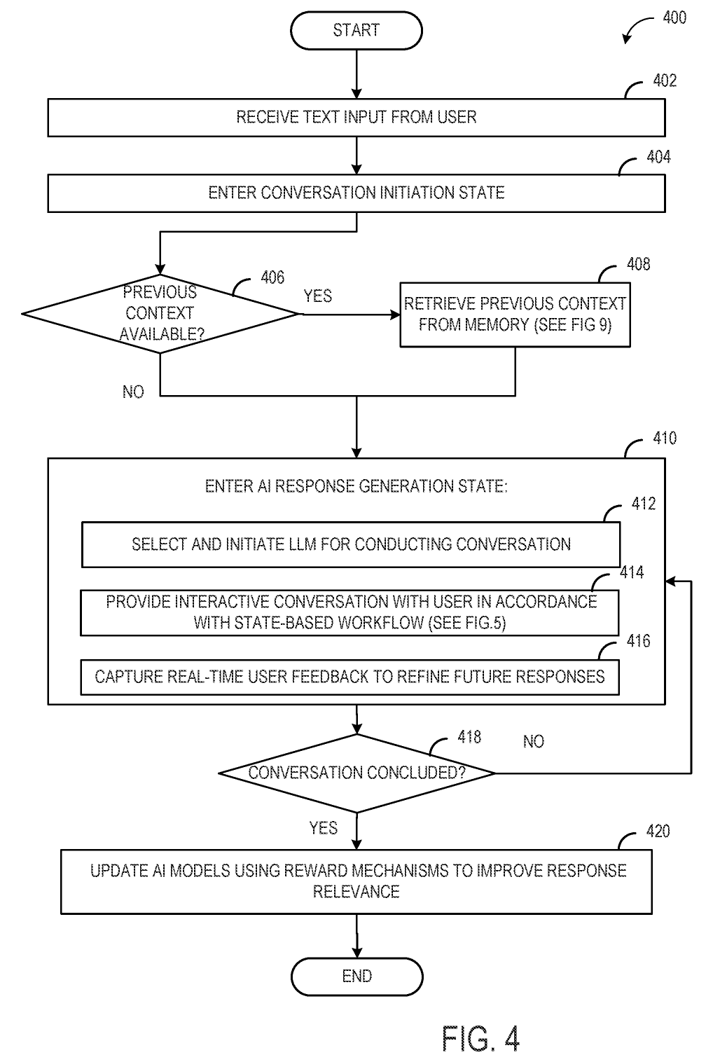

Non-transitory memory 206 may store at least a state management module 210, an AI module 212, a structured memory 220, an intent recognition module 222, and stored feedback 224. AI-based conversational system 200 may be configured to generate responses to text input (e.g., queries) submitted by user 201 via UI 232. Specifically, non-transitory memory 206 may include instructions that, when executed by processor 204, cause AI-based conversational system 200 to conduct one or more of the steps of method 400 for conducting an interactive conversation with user 201, described in more detail below in reference to FIG. 4, as well as other methods described herein in reference to subsequent figures.

The text input may be received at AI module 212, where the text input may be processed by one or more specialized AI agents 218. The one or more specialized AI agents 218 may correspond to various processing workflows that may be performed to generate a response based on the text input. Based on the text input, an appropriate workflow and AI agent to perform the workflow may be selected. The workflow may include, for example, retrieving relevant portions of previous conversations from structured memory 220 to be used as context for processing the text input. The workflow may include submitting the text input and the context to LLM 215. The workflow may include receiving a response from LLM 215 and performing one or more validation checks of the response. If the validation checks pass, the response may be displayed to user 201 via UI 232. If the validation checks do not pass, user 201 may be prompted to clarify the text input.

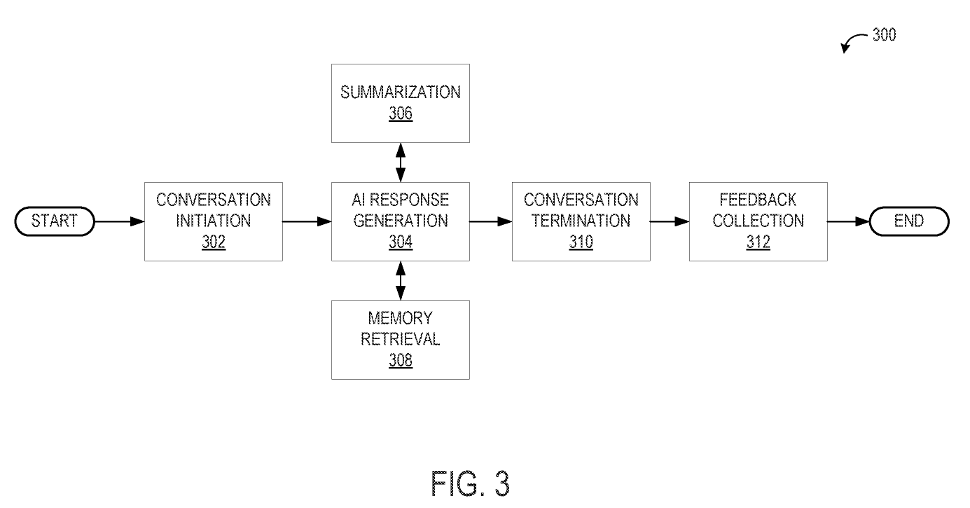

State management module 210 may manage a state of AI-based conversational system 200. That is, AI-based conversational system 200 may have a plurality of operational states. Each state of the plurality of operational states may provide constraints for performing a relevant workflow. In response to receiving the text input, state management module 210 may determine and enter into an appropriate state for addressing the text input. The operational states are described in greater detail below in reference to FIG. 3.

For example, in response to receiving a first text input, AI-based conversational system 200 may enter a first state. While in the first state, a first context or set of contexts may be retrieved from structured memory 220, and a first specialized agent 218 may be selected to perform a first workflow on the first text input. The first specialized agent 218 may submit the text input and the first context to LLM 215, and may receive a first response back from LLM 215. The first specialized agent 218 may perform a first set of actions to validate the first response, and the first response may be displayed to user 201 via UI 232. User 201 may provide feedback regarding an accuracy or suitability of the first response, which may be saved in stored feedback 224. The feedback may be used for further refining or retraining of LLM 215 and/or specialized AI agents 218.

User 201 may read the first response, and submit a second text input to AI-based conversational system 200. In response to receiving the second text input, AI-based conversational system 200 may enter a second, different state. While in the second state, a second context or set of contexts may be retrieved from structured memory 220, and a second specialized agent 218 may be selected to perform a second workflow on the second text input. The second specialized agent 218 may submit the text input and the second context to LLM 215, and may receive a second response back from LLM 215. The second specialized agent 218 may then perform a second set of actions to validate the second response, in accordance with the second workflow. Because the outputs generated by the LLM within each state are provided with contextual information, tools, and resources specific to that state, responses of the LLM may be more tightly controlled and an amount of hallucination of the LLM may be reduced as compared with an alternative, non-state-based conversational system.

Intent recognition module 222 may monitor an intent of user 201 across a plurality of text inputs. Intent recognition module 222 may perform natural language processing (NLP) on the text input and may rely on one or more AI/ML models to determine the intent using techniques known in the art. The AI/ML models may include third-party tools. If intent recognition module 222 detects a shift in the intent of the user, such as a change in a type of data user 201 is interested in, intent recognition module 222 may select a different workflow and a different specialized AI agent to perform the workflow.

AI-based conversational system 200 may be communicatively coupled (e.g., via a network) with one or more software tools 270 and one or more data sources 272, which may be used by AI-based conversational system 200 to generate responses to queries submitted to AI-based conversational system 200 by user 201. More specifically, software tools 270 and data sources 272 may be used to retrieve or generate contextual information (e.g., context) that may be submitted to LLM 215 along with the queries. Data sources 272 may include, for example, policies to be adhered to with respect to using the data established by a content owner, relevant organization, or regulatory body, including privacy and security policies. Data sources 272 may include cost data of various services relating to the data, such as pricing models, historical or current prices and costs, and the like. Data sources 272 may include various reference materials including, as a non-limiting list, medical literature or guidelines, government regulations, technical specifications documents, user manuals, etc. The use of software tools 270 and data sources 272 are described in greater detail below. It should be appreciated that the examples of software tools and data sources provided herein are for illustrative purposes, and other types of tools and resources may be included without departing from the scope of this disclosure.

Additionally, AI-based conversational system 200 may be communicatively coupled to one or more other LLMs 274, which may be used to validate or confirm responses generated by LLM 215, in some examples. For example, the one or more LLMs 274 may include publicly available large language models (LLMs) such as those produced by OPENAI, META AI, AI21, ANTHROPIC, and/or COHERE, or other companies/projects.

FIG. 3 shows a schematic diagram of an exemplary state graph 300, which shows various operational states that AI-based conversational system 200 of FIG. 2 may enter into when conducting an interactive conversation with a user (e.g., user 201). AI-based conversational system 200 may enter into a state of state graph 300 when certain criteria are met. State graph 300 enforces a structured approach by representing the conversation as a series of well-defined states. This ensures that the dialogue flows logically, with each state handling a specific task in the overall conversation process. It minimizes the risk of state confusion or lost context, particularly in complex or long-running interactions.

When the user first interacts with AI-based conversation system 200, for example, by entering a text input into a query field of UI 232, AI-based conversation system 200 may enter into a conversation initiation state 302. During the conversation initiation state 302, an initial context for the conversation may be established, and various routines and metadata may be initialized. From the conversation initiation state 302, AI-based conversation system 200 may enter an AI response generation state 304. During the AI response generation state 304, AI-based conversation system 200 may determine one or more workflows that may be followed or performed to adequately respond to the text input. The workflows may be performed in series, or in parallel, in some examples. By performing the workflows in parallel, an efficiency of AI-based conversation system 200 may be increased, and an amount of time taken to respond to a text input may be reduced.

AI-based conversation system 200 may instantiate and assign tasks inherent to a workflow of the one or more workflows to one or more specialized AI agents (e.g., specialized AI agents 218). In some examples, the one or more specialized AI agents may be selected by an agent manager AI agent, itself a specialized AI agent. Each selected specialized AI agent may perform its assigned workflow, and generate an output. In some examples, the output of a first specialized AI agent may be an input into a second specialized AI agent. In other examples, the output of the first specialized AI agent may be combined with the output of the second specialized AI agent, and the combined output may be incorporated into the response to the user.

Performing an assigned workflow may include retrieving additional contextual data from the memory and/or external sources (e.g., software tools 270 and/or data sources 272) that are relevant to the text input, and submitting a prompt to LLM 215 with the additional context. Performing the assigned workflow may also include performing a customized validation of the response, as described in greater detail below.

If conditions are met, AI-based conversation system 200 may enter a summarization state 306. The conditions for entering the summarization state 306 may include a number of tokens generated by LLM 215 exceeding a threshold number of tokens. In other words, when AI-based conversation system 200 submits text inputs of the user into LLM 215, LLM 215 may tokenize the text inputs and store the tokens in memory. LLM 215 may generate a response by predicting a sequence of tokens to output, based on the text input. The tokens in the response may also be stored in the memory. The stored tokens provide context for the ongoing conversation. As the number of tokens grows, more memory (e.g., non-transitory memory 206) of AI-based conversation system 200 is consumed, and more processing resources (e.g., processor 204) are consumed in generating responses based on the stored context. An amount of time taken by AI-based conversation system 200 to respond to user queries may also increase as the number of tokens stored increases.

To increase an efficiency of AI-based conversation system 200 in responding to the user queries, AI-based conversation system 200 may assign a specialized summarization AI agent to monitor the number of tokens generated by LLM 215 over the course of the interactive conversation between the user and AI-based conversation system 200. If or when the number of tokens increases above the threshold number of tokens, the summarization AI agent may prompt LLM 215 to summarize the context (e.g., the conversation including the text inputs and responses). The summarization agent may determine, based on various criteria, decision matrices, models, etc., to what degree the context can or should be summarized. The various criteria may include a degree of detail included in the conversation, a number of interactions between the user and the system, an amount of available memory and/or processing resources of the system, etc. The summarization agent may then delete the context from the memory, and replace the context with the summarized context. By replacing the context with the summarized context, the amount of memory consumed by AI-based conversation system 200 and the amount of processing performed by processor 204 may be advantageously reduced, increasing an overall efficiency of AI-based conversation system 200.

Additionally or alternatively, if conditions are met, AI-based conversation system 200 may enter a memory retrieval state 308. The conditions for entering the memory retrieval state 308 may include detecting that a text input of the user references past or ongoing conversations or projects. In such cases, parallel processing of the text input using a plurality of specialized AI agents may not be the most efficient way of processing the text input. Rather, a specialized memory-aware AI agent may be selected to respond to the text input. Similar to the summarization agent, the memory-aware AI agent may determine, based on various criteria, decision matrices, models, etc., which portions of the context of the conversation to retrieve. The various criteria may include a degree of detail included in the conversation, a number of interactions between the user and the system, an amount of available memory and/or processing resources of the system, etc.

If or when AI-based conversation system 200 detects that the user wishes to terminate the conversation, AI-based conversation system 200 may enter into a conversation termination state 310. In the conversation termination state 310, various summary information may be collected and stored. Additionally, one or more specialized AI agents generated by the system may be terminated, releasing resources for other tasks.

After the conversation has been terminated, AI-based conversation system 200 may enter into a feedback collection state 312. During the feedback collection state 312, feedback from the user may be collected and stored. The feedback may be used to further train or refine LLM 215 and/or one or more of the specialized AI agents.

Referring now to FIG. 4, a high level method 400 is shown for an AI-based conversational system, such as AI-based conversational system 200 of FIG. 1, for conducting an interactive conversation with a user (e.g., user 201). One or more steps of method 400 and the other methods included in this disclosure may be performed by a processor of the AI-based conversational system (e.g., processor 204) in accordance with instructions stored in a memory of the AI-based conversational system (e.g., non-transitory memory 206).

Method 400 starts at 402, where the method includes receiving a text input from the user. In various examples, the text input may be received via a text input field of a GUI such as UI 232 of FIG. 2.

At 404, in response to receiving the text input from the user, method 400 includes entering a conversation initiation state of the AI-based conversational system. While in the conversation initiation state, the AI-based conversational system may perform a series of actions to set up an initial context for a dialogue with the user. This may involve greeting the user, establishing the purpose of the conversation, and/or initializing any metadata stored in the memory with respect to the interactive conversation. The goal of the conversation initiation state may be to develop a clear starting point that orients both the AI-based conversational system and the user towards a set of goals of the user. In the conversation initiation state, a first set of predefined resources, including data stored in the memory, internal or external tools (software tools 270), external data sources (e.g., data sources 272), and conversational context data may be relied on by the AI-based conversational system or an LLM selected by the AI-based conversational system. The first set of predefined resources may not be available during other states of the AI-based conversational system.

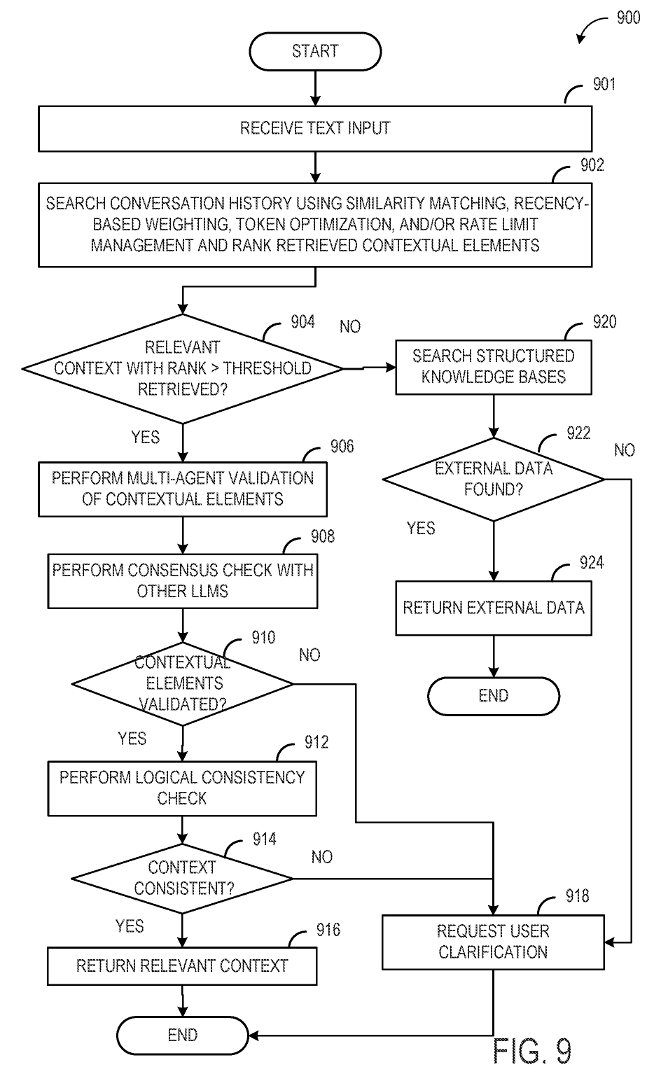

At 406, method 400 includes determining whether a previous context is available for the conversation. For example, the previous context may be a prior conversation with the user stored in the memory. If at 406 it is determined that no previous context is available, method 400 proceeds to 410. Alternatively, if at 406 is determined that the previous context is available, method 400 proceeds to 408. At 408, method 400 includes retrieving the previous context from the memory. Retrieving the previous context from the memory described in greater detail below, in reference to FIG. 9. After the previous context is retrieved from the memory, method 400 proceeds to 410.

At 410, method 400 includes entering an AI response generation state of the AI-based conversational system. Because responding to the text inputs of the user entails a different workflow than in the conversation initiation state, during the AI response generation state, a second set of predefined resources may be relied on by the AI-based conversational system, that are different from the first set of predefined resources. For example, the first set of predefined resources may include a metadata file with information about the user and a history of the user’s interaction with the AI-based conversational system, which is relevant to initiating a conversation with the user, but not relevant to answering questions posed by the user. The second set of predefined resources may include a set of LLMs available to the AI-based conversational platform, and criteria for selecting an LLM of the set of LLMs that is most appropriate for responding to the user. By associating the different sets of predefined resources with different states of the AI-based conversational system, a context within which prompts are submitted to a selected LLM may be more tightly controlled, which may reduce a capacity of the selected LLM to hallucinate.

At 412, method 400 includes selecting and initiating an LLM for conducting a conversation with the user. The LLM may be one of the plurality of LLMs available to the AI-based conversational system (e.g., the LLMs 274).

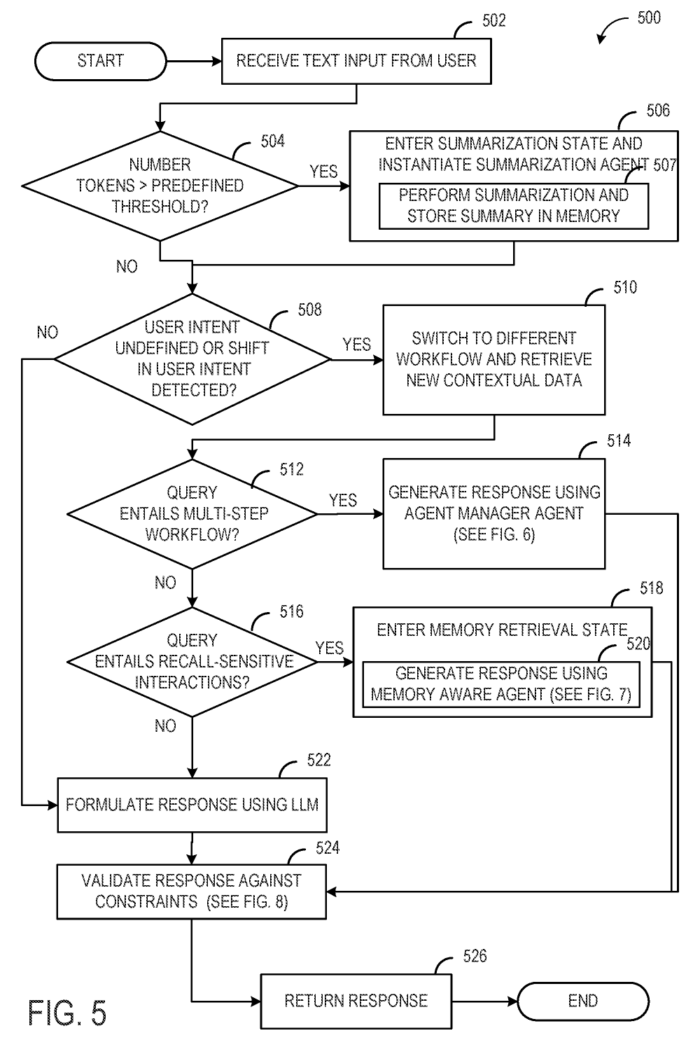

At 414, as a result of being in the AI response generation state, method 400 includes conducting the conversation with the user using the selected LLM, in accordance with a state-based workflow. Conducting the conversation with the user in accordance with the state-based workflow may include determining an appropriate context for answering the question of the user or following instructions provided by the user, and submitting a prompt including the text input to the LLM (LLM 215). Conducting the conversation with the user in accordance with the state-based workflow is described in greater detail below in reference to FIG. 5.

At 416, method 400 includes capturing real-time user feedback to refine future responses of the AI-based conversational system. The real-time user feedback may be collected in various ways. In some examples, the feedback may include explicit approval or disapproval of the user, such as via thumbs up or thumbs down ratings via control elements in the UI (e.g., UI 232). Additionally or alternatively, the feedback may be generated by user corrections of the response, and/or follow-up requests of the user asking for further clarification of the response or aspects of the response. An early termination of the conversation may indicate dissatisfaction with the response, which may be registered as feedback. The real-time user feedback may be stored in the memory (e.g., feedback 224 of FIG. 2) to be incorporated into additional training cycles of the LLM and/or other AI models of the AI-based conversational system. Additionally, a weighting of the response may be adjusted, which may help the AI models learn to prioritize verified information sources in generating the response.

At 418, method 400 includes determining whether the conversation has been concluded. If at 418 it is determined that the conversation has not been concluded, method 400 proceeds back to 412. Alternatively, if at 418 it is determined that the conversation has been concluded, method 400 proceeds to 420.

At 420, method 400 includes updating one or more AI models of the AI-based conversational system using reward mechanisms, to improve response relevance. The one or more AI models may include the selected LLM used to generate responses to the user, as well as other AI models relied on by the AI-based conversational system to edit prompts submitted to the LLM, validate responses outputted by the LLM, or other tasks performed by the AI-based conversational system. The reward mechanism may include a model, such as a rules-based model or an ML model, that may assign rewards to responses based on various criteria. For example, responses that receive positive user feedback may be rewarded, and responses that are validated against a knowledge base may also be rewarded. If a response receives negative feedback, the reward model may also penalize an associated response pathway, which may reduce the likelihood of the pathway being selected in future interactions.

The AI-based conversational system may also continuously refine response generation based on the collected user feedback. AI updates may be applied through fine-tuning on user feedback data (e.g., batch updates on frequently corrected responses), dynamic prompt adaptation, where successful response patterns are reinforced in real-time, as well as confidence scoring adjustments, which may reduce over-confidence in weak response areas. As a result, the AI models and LLMs used by the AI-based conversational system may evolve without manual training.

FIG. 5 shows a method 500 for conducting a conversation with the user of the AI-based conversational system, which may be performed by the AI-based conversational system as part of high-level method 400 described above with respect to FIG. 4.

Method 500 begins at 502, where the method includes receiving the text input from the user. At 504, method 500 includes determining whether a number of tokens generated by a tokenization of the text input by the LLM exceeds a predefined threshold number of tokens. If at 504 the number of tokens exceeds the predefined threshold number of tokens, method 500 proceeds to 506, where method 500 includes entering a summarization state of the AI-based conversational system.

As a result of being in the summarization state, a third set of predefined resources may be accessed by the AI-based conversational system that is different from the first and second sets of predefined resources. That is, the first and second sets of predefined resources may not be available to the AI-based conversation system during the summarization state.

In the summarization state, a new workflow may be followed where a summarization AI agent may be selected and instantiated. At 507, the summarization AI agent performs a summarization of the existing conversation and stores the summary in the memory. That is, during long interactions between the user and the AI-based conversational system, the summarization agent periodically compiles a summary of the conversation to maintain clarity and ensure that both the AI-based conversational system in the user remain aligned on the conversations history. The summary creates a concise snapshot of the dialogue, which may be referenced later for context or decision-making. The third set of predefined resources made available for the summarization may include, for example, criteria, lookup tables, tools, and/or models (AI models, statistical models, probabilistic models, etc.) for determining to what degree the conversation is summarized, how long the summary should be, what elements of the conversation should be included in the summary, and the like.

Alternatively, if at 504 it is determined that the number of tokens does not exceed the predefined threshold, method 500 proceeds to 508. At 508, method 500 includes determining whether an intent of the user is undefined, or whether a shift in the intent of the user is detected. The shift in the intent of the user may be determined by an intent recognition module of the AI-based conversational system, such as intent recognition module 222 of FIG. 2. Specifically, the AI-based conversational system continuously monitors the conversation flow to determine when the user’s intent changes revolves. For such purpose, natural language understanding (and LU) and/or natural language processing (NLP) models and/or intent classification algorithms may be used to determine the user goal at different stages of the conversation. If a shift in intent is detected, the AI-based conversational system may transition into a different state to facilitate a new workflow, instead of assuming continuity with prior interactions.

If at 508 the intent of the user is clear and consistent (e.g., not undefined and with no shift in intent being detected), method 500 proceeds to 522, where method 500 includes formulating a response using the LLM. Alternatively, if at 508 the intent is either undefined or a shift in the intent is detected, method 500 proceeds to 510.

At 510, method 500 includes switching to a different workflow and retrieving new contextual data. That is, if a shift in the user intent is detected, a current workflow of the AI-based conversational system may no longer be most suitable for addressing the concerns of the user, and a new workflow may be selected. The new workflow may entail retrieving one or more additional contexts from the memory. In some examples, the new workflow may entail transitioning to a different state where different predefined resources are accessed, as described above.

For example, the user may initially ask where a certain type of data may be found in datasets stored in a content brokering platform associated with the AI-based conversational system (e.g., datasets 104 of FIG. 1). The user may find data that the user wishes to extract and store in a new dataset on the content brokering platform. The intent of the user may then shift from wanting to find data, to wanting to determine a cost of the data that has been discovered. For example, a text input of the user may include a question about a price of using the data established by the owner of the data. The AI-based conversational system may detect the shift in intent, and switch from a data-search workflow to a data-purchasing workflow. In accordance with the data-purchasing workflow, the AI-based conversational system may retrieve pricing and/or subscription model information regarding the data from the memory. The AI-based conversational system may submit the query of the user to the LLM with a new context, where the new context includes the retrieved pricing and/or subscription model information. The LLM may determine an answer to the query based on the new context, and the AI-based conversational system may display the answer to the user on a display device.

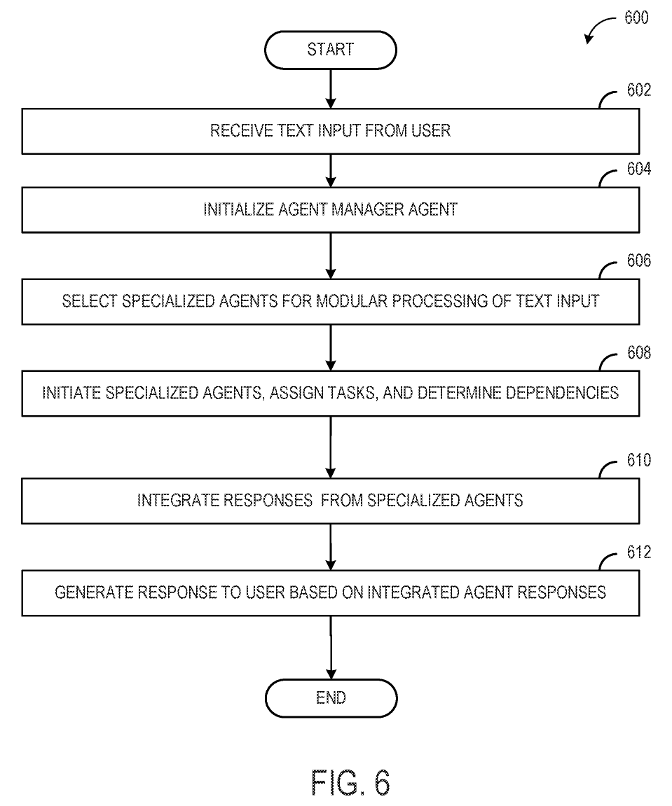

Switching to the relevant workflow and retrieving new contextual data may include, at 512, determining whether the query of the user entails a multi-step workflow. If at 512 it is determined that the query entails a multi-step workflow, method 500 proceeds to 514. At 514, method 500 includes generating a response to the query using an agent manager AI agent of the specialized AI agents of the AI-based conversational system. Generating the response to the query using the agent manager agent is described in greater detail below in reference to FIG. 6. The model then proceeds to 524.

If at 512 it is determined that the query does not entail a multi-step workflow, method 500 proceeds to 516. At 516, method 500 includes determining whether the query entails recall-sensitive interactions. If at 516 it is determined that the query entails recall-sensitive interactions, method 500 proceeds to 518.

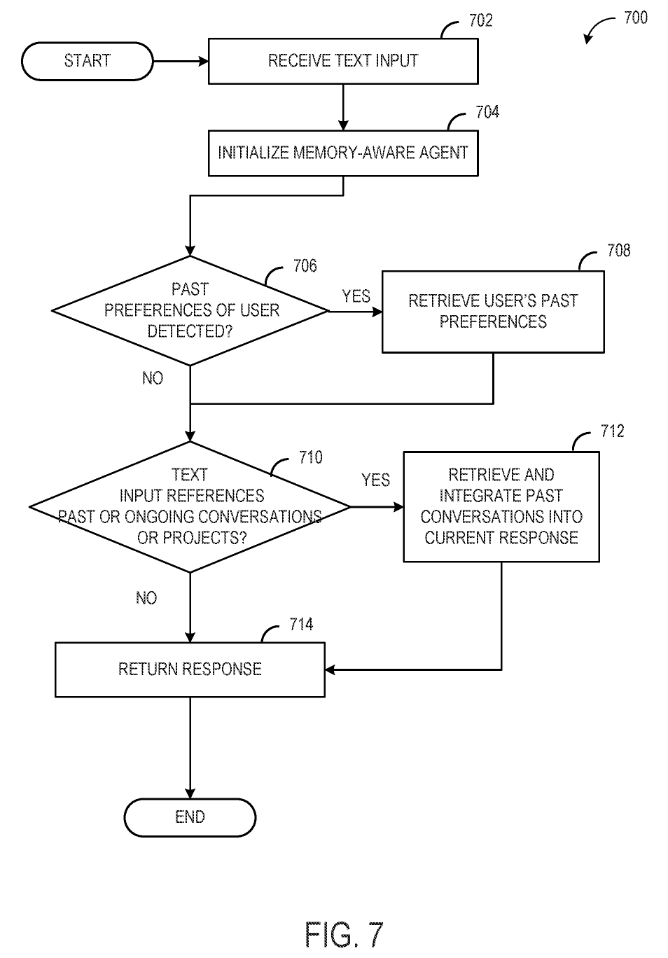

At 518, method 500 includes entering a memory retrieval state of the AI-based conversational system. During the memory retrieval state, a fourth set of predefined resources may be made available to the AI-based conversational system, which may replace other predefined resources of a previous state. The fourth set of predefined resources may include, for example, criteria, tools, and/or models used to determine portions of previous conversations to retrieve based on the text input. For example, in some cases, targeted portions of a previous conversation with specific information may be retrieved, while in other cases, larger portions of the previous conversation may be retrieved to provide context for an ongoing project. In response to being in the memory retrieval state, at 520, the AI-based conversational system may generate a response to the user’s query using a memory aware AI agent of the specialized AI agents. Generating the response using the memory aware AI agent described in greater detail below in reference to FIG. 7. After 520, the model then proceeds to 524.

Alternatively, if at 516 it is determined that the query does not entail recall-sensitive interactions, method 500 proceeds to 522. At 522, method 500 includes formulating a response directly using the LLM, meaning, not using a specialized AI agent. In other words, in some cases, a specialized AI agent may be instantiated by the AI-based conversational system that is specially equipped or limited to performing a certain task. For example, the memory-aware AI agent may be specialized at retrieving information from previous conversations, but may be restricted from accessing information not found in the previous conversations. The memory-aware AI agent may determine an appropriate prompt to submit to the LLM, including appropriate context to provide to the LLM. Because of the restrictions imposed on the memory-aware AI agent, the LLM may be less likely to hallucinate than if the prompt were submitted by a different agent, or without using a specialized AI agent. Additionally, by using the memory-aware AI agent rather than a different specialized AI agent, or not using a specialized AI agent, an amount of memory and processing resources of the AI-based conversational system may be advantageously reduced.

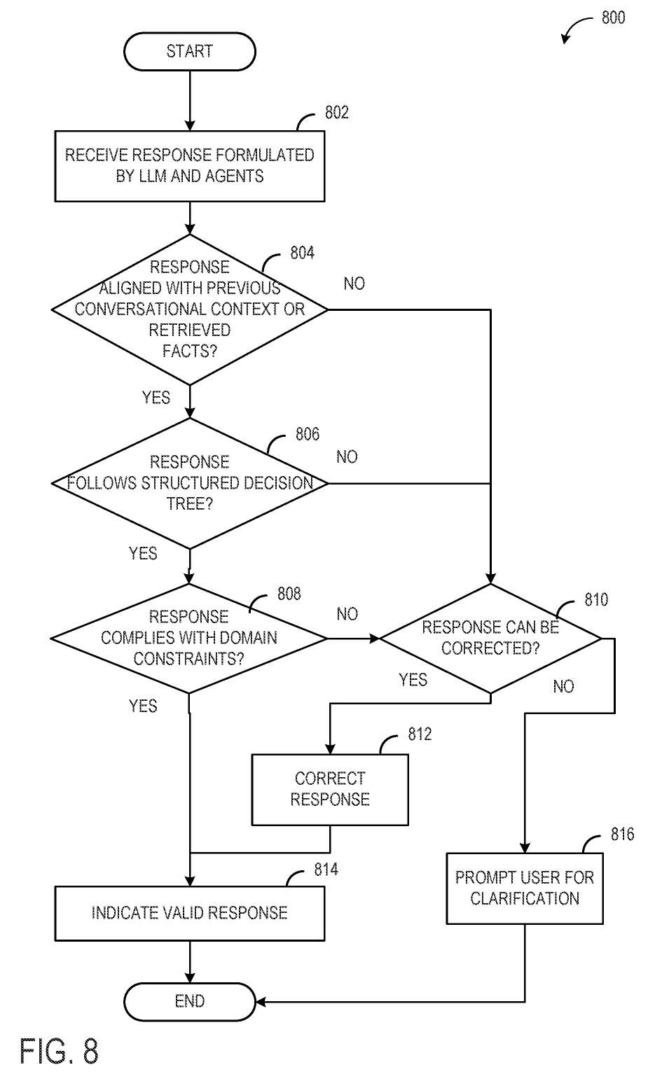

At 524, method 500 includes validating the response received from the LLM against a set of constraints. Validating the response received from the LLM is described in greater detail below in reference to FIG. 8. After the response has been validated, at 526, method 500 includes returning the response, and method 500 ends.

Referring now to FIG. 6, a method 600 is shown for generating a response to a user input when a multi-step workflow is detected. Method 600 may be performed by a specialized AI agent of the AI-based conversational system, such as an agent manager AI agent.

Method 600 begins at 602, where method 600 includes receiving the text input from the user. At 604, method 600 includes initializing the agent manager agent. When the agent manager agent is initialized, it may be provisioned with various resources, such as memory context, access to a shared dataset repository, communication channels with sub-agents, and application programming interface (API) permissions to perform read/write operations. Constraints may also be imposed on the agent manager agent, such as bounded compute limits, token budget restrictions per task, hierarchical authority boundaries, and execution timelines to ensure efficient coordination. Instructions may be provided to the agent manager agent in the form of structured prompts or objective definitions, which may outline an overarching goal, specify sub-agent roles, and/or define coordination protocols. These instructions may also include evaluation metrics and fallback procedures to maintain robustness in dynamic environments.

At 606, method 600 includes selecting one or more specialized AI agents for modular processing of the text input. In some examples, the AI-based conversational system may enter into a different state associated with the multi-step workflow, where the AI-based conversational system may avail of predefined resources that specify the set of specialized AI agents available for processing the multi-step workflow and criteria for selecting the specialized AI agents.

At 608, method 600 includes instantiating the selected specialized AI agents, and assigning tasks to the specialized AI agents. Assigning the tasks to the specialized AI agents may include determining dependencies between the specialized AI agents. In other words, a task entailed by the multi-step workflow may include a series of steps that may be performed by a plurality of specialized AI agents in a sequence. In such cases, method 600 may include determining an order of processing by the plurality of specialized AI agents, and the outputs and inputs of each of the specialized AI agents during the multi-step workflow.

As an example of a multi-step workflow, a user of a content brokering platform, such as a content licensor 140 of content brokering platform 100 of FIG. 1, may seek information about products sold in a target market, where product information is included in a dataset included on the content brokering platform (e.g., datasets 104). The user may specify the dataset and enter in a text input such as, "Please create a new dataset of images of all products included in the dataset that are from the highest grossing store in Q1 2023 of my favorite purchase category." The agent manager agent may then perform a series of queries to different resources to generate an answer. For example, the agent manager agent may first look up the user’s favorite purchase category from a set of user preferences stored in a memory of the AI-based conversational system, and may determine that the user’s favorite purchase category is video games. The agent manager agent may then search the dataset by executing a structured query language (SQL) query to determine the highest grossing store in Q1 2023 that sells video games. The SQL query may return a response indicating that GameStop sold $XXX,XXX.XX in Q1 2023. The agent manager agent may then task a retrieval-augmented generation (RAG) agent with determining the types of products GameStop sells. The RAG agent may retrieve relevant information from text sources like GameStop_promo.html, GameStop_annual_report.pdf, etc. The RAG agent may return a first sentence from a first source, such as "Shop GameStop, the world's largest retail gaming and trade-in destination for Xbox, PlayStation, and Nintendo games, systems, consoles & accessories." (Source AAA). The RAG agent may return a second sentence from a second source, such as "GameStop Corp (GameStop) is a retailer of video games. The company merchandises and sells video game hardware and software products, pre-owned and value video games, consumer electronics, collectible products and wireless services." (Source BBB). The agent manager agent may then submit a prompt to an LLM to create a dataset of image files of products included in the categories included in the information retrieved from the RAG agent. When the dataset is created, the AI-based conversational system may output to the user a response such as, “I've prepared a dataset of "GameStop Product Images" for you.”

At 610, method 600 includes integrating responses from the specialized AI agents, in accordance with the above mentioned dependencies, and at 612, method 600 includes generating a response to the user based on the integrated responses of the specialized AI agents. Method 600 ends.

Referring now to FIG. 7, a method 700 is shown for an AI-based conversation system for generating a response during the interactive conversation using a memory-aware agent that is specialized for retrieving prior context of the interactive conversation. Method 700 performed as part of method 500 described above in reference to FIG. 5.

Method 700 begins at 702, where method 700 includes receiving the text input from the user. At 704, method 700 includes initializing the memory-aware agent. When the memory-aware agent is initialized, the memory-aware agent may be provisioned with access to long- and short-term memory modules, allowing it to persist context across tasks and recall relevant historical interactions. Resources may available to the memory-aware agent may include access to an agent memory graph, semantic search capabilities, and dynamic context windows. Constraints may be imposed on the memory-aware agent, such as memory size limits, time-based decay of older context, and access permissions tied to specific datasets. Instructions may be provided through system prompts and memory injection routines, which guide the agent on how to retrieve, update, and prioritize memory segments based on task relevance and interaction history.

At 706, method 700 includes determining whether past preferences of the user are detected. If at 706 past preferences of the user are detected, method 700 proceeds to 708. At 708, method 700 includes retrieving the user’s past preferences. The user’s past preferences may be used to personalize agent behavior, select agents/sub-agents to use for the task, optimize decision-making pathways, and dynamically adapt responses or prioritize tasks to align with the user’s historical patterns and intent. In this way, a more contextually aware and efficient interaction may be enabled, improving relevance and reducing a reliance on repetitive input from the user. If at 706 past preferences of the user are not detected, method 700 proceeds to 710.

At 710, method 700 includes determining whether the text input references past or ongoing conversations or projects. If at 710 it is determined that the text input references past or ongoing conversations or projects, method 700 proceeds to 712. At 712, method 700 includes retrieving and integrating the past conversations regarding the ongoing conversations or projects into a current response.

Alternatively, if at 710 it is determined that the text input does not reference past or ongoing conversations or projects, method 700 proceeds to 714. At 714, method 700 includes returning the response, and method 700 ends.

Referring now to FIG. 8, a method 800 is shown for an AI-based conversation system for validating a response generated by an LLM, such as LLM 215 of FIG. 2. Method 800 performed as part of method 500 described above in reference to FIG. 5.

Method 800 begins at 802, where method 800 includes receiving a response formulated by the LLM and/or one or more specialized AI agents, as described above. That is, a specialized AI agent may submit a prompt to the LLM, receive a response back from the LLM, and edit the response generated by the LLM, at which point the edited response may be validated in accordance with method 800.

At 804, method 800 includes determining whether the response is aligned with previous conversational context or facts retrieved from the memory or from an external data source (e.g., data sources 272). For example, the AI-based conversation system may submit one or more additional prompts to the LLM instructing the LLM to compare the response with the previous conversational context and/or validate facts of the response using external data sources (e.g., data sources 272). The AI-based conversation system may indicate to the LLM, for example, a set of data sources to use to validate the response, based on a domain of the text input.

If at 804 it is determined that the response is not aligned with the previous conversational context or retrieved facts, method 800 proceeds to 810. Alternatively, if at 804 it is determined that the response is aligned with the previous conversational context or retrieved facts, method 800 proceeds to 806.

At 806, method 800 includes determining whether the response follows a structured decision tree. This involves evaluating whether an output of an agent corresponds to a predefined set of logical branches or decision points, typically encoded to handle known scenarios or workflows. Structured decision trees are often used to ensure predictable, explainable behavior in high-confidence domains. If the response matches a valid path within the decision tree, it indicates adherence to expected reasoning patterns; otherwise, it may trigger a fallback or escalation protocol for further validation or correction.

If at 806 it is determined that the response does not follow a structured decision tree, it may be inferred that the response is not valid, and method 800 proceeds to 810. Alternatively, if at 806 it is determined that the response does follow a structured decision tree, method 800 proceeds to 808.

At 808, method 800 includes determining whether the response complies with constraints imposed by a domain of the text input. The domain may be established by analyzing the semantic context of the user’s input, leveraging metadata associated with the conversation (e.g., topic tags, user role, or session purpose), or referencing an external knowledge base or ontology that defines the scope and boundaries of permissible content. This domain definition helps the system apply appropriate linguistic, procedural, and ethical constraints—ensuring that generated responses remain relevant, accurate, and aligned with the expectations or regulations of the specified context (e.g., legal, medical, educational). When the domain is established, the AI-based conversational system may indicate a set of internal or external resources to be consulted to determine whether the response complies with the domain constraints. For example, the set of internal or external resources may be retrieved from a lookup table stored in a memory of the AI-based conversational system (e.g., non-transitory memory 206 of FIG. 2) based on the domain.

If at 808 it is determined that the response complies with the domain constraints, method 800 proceeds to 814, where a valid response is indicated and method 800 ends. Alternatively, if it is determined at 808 that the response does not comply with the domain constraints, method 800 proceeds to 810.

At 810, method 800 includes determining whether the response can be corrected. This involves evaluating whether a deviation from domain constraints is minor and can be resolved through automated techniques such as re-ranking alternative completions, regenerating the response with adjusted prompts, or referencing domain-specific correction rules. The AI-based conversational system may also leverage error detection heuristics or fine-tuned classifiers trained to identify recoverable errors. For example, if a medical domain response includes an outdated drug dosage, the AI-based conversational system may detect this inconsistency against a current pharmacopeia, and auto-correct it to reflect updated guidance, thus enabling the response to be revised and realigned with domain constraints before delivery.

If it is determined that the response can be corrected, method 800 proceeds to 812, where the response is corrected. After correcting the response, method 800 proceeds to 814, where a valid responses indicated and method 800 ends.

If at 810 it is determined that the response cannot be corrected, method 800 proceeds to 816. At 816, method 800 includes prompting the user for a clarification of the text input, and method 800 ends.

Referring now to FIG. 9, a method 900 is shown for an AI-based conversation system for retrieving a previous conversational context of a conversation from a memory of the AI-based conversation system, based on a text input of a user. The previous conversational context may comprise various individual contextual elements of a prior conversation with the user, which may be scattered throughout the prior conversation. That is, the previous conversational context of the conversation may not include an entire conversation, or a summarized version of a previous conversation, but rather select portions of the previous conversation and/or informational elements included at different times in the previous conversation. Thus, method 900 addresses the task of selecting specific elements of the previous conversation that are relevant to the text input. Method 900 performed as part of method 400 described above in reference to FIG. 4. Method 900 may be performed prior to engaging with the user as described in method 500 of FIG. 5.

Method 900 begins at 901, where method 900 includes receiving the text input. At 901, method 900 includes receiving the text input. At 902, method 900 includes searching a conversation history of the conversation for conversational elements that match the text input using similarity matching. Recency-based weighting may also be used, where, for example, messages are assigned priority weights that decay over time, using an exponential function. Different contextual elements that are retrieved from the conversation history may be ranked numerically, for example, on a scale from 1 to 10, or 1 to 100, based on a weighted similarity score.

Token optimization and rate limit management may be used, where efficiency is ensured under constraints on tokens per minute. Non-provisioned/serverless LLM endpoints cloud providers may enact some rate limits, such as a number of tokens per minute. Therefore, batch inferencing (e.g., where a collection of inferences is made based on initial timestamp and input tokens) may be used to support multiple concurrent users, track the input/output of tokens at different nodes of the graph, and optimize tokens at different levels (system prompt, human input, AI output, etc.). The batch inferencing may be optimized per minute, or per second, depending on the provider.

Token optimization may be bi-directional and may apply to the long-term and short-term memory of an agent within a specific conversation, or all conversations with the user or users of a certain job or team. Most accurate results may be generated with a robust short-term memory (for example, being able to quote a user), but if input token usage is above a threshold, a chronological summarization may be performed (and appended, if applicable) into the long term memory to preserve tokens. In the other direction, when too little information is given a prompt may be enhanced for certain context/subjects. One common example is in image generation, where a user does not need to know the best ways to prompt for a certain CLiP (SD3.5 v FLUX) and an LLM can enhance.

At 904, method 900 includes determining whether one or more relevant valid contextual elements are retrieved that have a ranking that exceeds a threshold rank. For example, the threshold rank may be 60, where if one or more retrieved contextual elements have a rank of 60 or above, the answer is YES, and if no contextual elements have a rank that exceeds 60, the answer is NO.

If at 904 it is determined that one or more relevant contextual elements have been retrieved, method 900 proceeds to 906. At 906, method 900 includes performing the multi-agent validation of the retrieved contextual elements. During the multi-agent validation, different specialized AI agents may perform different validation tasks.

At 908, method 900 includes performing a consensus check of the retrieved contexts using one or more different LLM’s. For example, this may include submitting a prompt including the text input, the retrieved contextual elements, and the conversation history to one or more LLM’s (e.g., LLM 215 and/or LLMs 274) instructing the one or more LLM’s to indicate whether the retrieved contextual elements match the text input. A similarity score may be used to determine similarity, such as a cosine similarity score.

At 910, method 900 includes determining whether the retrieved contextual elements are validated at steps 906 and/or 908. If one or more retrieved contextual elements are not validated at steps 906 and/or 908, method 900 may proceed to 918. At 918, method 900 includes requesting a clarification from the user with respect to whether the one or more retrieved contextual elements are valid, and method 900 ends.

Alternatively, if the retrieved contextual elements are validated at steps 906 and/or 908, method 900 proceeds to 912. At 912, method 900 includes performing a logical consistency check of the retrieved contextual elements. Performing the logical consistency check may include detecting whether internal contradictions exist within the retrieved contextual elements. For example, method 900 may include submitting a prompt including the retrieved contextual elements to the one or more LLM’s instructing the one or more LLM’s to indicate whether contradictory information is detected in the retrieved contextual elements.

At 914, method 900 includes determining whether the retrieved contextual elements are logically consistent, based on the logical consistency check. If at 914 it is determined that the retrieved contextual elements are logically consistent, method 900 proceeds to 916. At 916, method 900 includes returning the retrieved contextual elements, and method 900 ends. Alternatively, if at 914 it is determined that one or more of the retrieved contextual elements are not logically consistent, method 900 proceeds to 918, where a clarification is requested from the user, and method 900 ends.

Returning to step 904, if at 904 no contextual elements are retrieved at 902 that have a rank that is greater than the threshold rank, method 900 proceeds to 920. At 920, method 900 includes searching one or more structured knowledge bases for a context of the text input. The one or more structured knowledge bases may include internal data sets or databases, as well as external data sources (e.g., data sources 272). The one or more structured knowledge bases may be selected based on a domain of the text input, for example.

At 922, method 900 includes determining whether external data providing a context for the text input is found in the structured knowledge bases. If external data providing the context for the text input is found, the external data is returned at 924, and method 900 ends. Alternatively, if no external data providing the context for the text input is found at 920, method 900 proceeds to 918, where method 900 includes requesting clarification from the user, and method 900 ends.

The technical benefits of the disclosed AI-based conversation system include significantly reduced AI hallucinations through constrained response pathways, optimized computational resource utilization via dynamic memory management, enhanced response accuracy through specialized agent collaboration, improved contextual awareness via sophisticated intent recognition, continuous system improvement through algorithmic reinforcement learning, and efficient processing through adaptive execution modes. This comprehensive approach represents a significant advancement in AI conversational systems, addressing key limitations in current implementations while providing a scalable, efficient, and accurate solution for AI-driven interaction.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative and should not be construed to be limiting in any manner.

1. An artificial intelligence (AI)-based conversational system, comprising;
a processor; and
a memory storing instructions that when executed, cause the processor to:
receive a text input from a user of the AI-based conversational system;
enter into a state of the AI-based conversational system, based on the text input;
retrieve a context of the text input from the memory, based on the state;
submit a prompt to a large language model (LLM), the prompt including the text input and the context;
receive a response to the prompt from the LLM;
perform a validation of the response;
in response to the validation being successful:
output the response to a display device; and
store the text input and the response in the context; and
in response to the validation not being successful:
prompt the user for clarification of the text input.

2. The AI-based conversational system of claim 1, wherein the AI-based conversational system is a component of a content brokering platform that provides access to content owned by various owners for training an AI model, and the text input includes at least one of:
a query with respect to data included in the content; and
instructions for extracting the data from the content.

3. The AI-based conversational system of claim 2, wherein the text input includes:
instructions for creating and storing a dataset in the memory, the dataset including data extracted from a first dataset of the content and data extracted from a second dataset of the content.

4. The AI-based conversational system of claim 1, wherein further instructions are stored in the memory that when executed, cause the processor to:
select a workflow to be performed and a specialized AI agent of a plurality of specialized AI agents of the AI-based conversational system to perform the workflow, based on the text input;
wherein the workflow includes:
retrieving one or more additional contexts from the memory and/or external sources;
submitting the prompt to the LLM with the one or more additional contexts; and
performing a customized validation of the response.

5. The AI-based conversational system of claim 4, wherein further instructions are stored in the memory that when executed, cause the processor to:
detect a shift in an intent of the user based on natural language processing (NLP) of the text input, and in response, select a different workflow and a different specialized AI agent to perform the workflow.

6. The AI-based conversational system of claim 4, wherein the plurality of specialized AI agents includes a summarization agent that in response to a number of tokens of the context exceeding a threshold number of tokens, submits a prompt to the LLM to generate a summary of the context, and replaces the context in the memory with the summary of the context.

7. The AI-based conversational system of claim 4, wherein the plurality of specialized AI agents includes a memory-aware agent that in response to detecting that the text input references past or ongoing conversations or projects, retrieves a previous context of the text input from the memory.

8. The AI-based conversational system of claim 4, wherein the plurality of specialized AI agents includes an agent manager agent that in response to detecting that the text input references a multi-step workflow, generates a response using one or more other specialized AI agents of the AI-based conversational system.

9. The AI-based conversational system of claim 1, wherein further instructions are stored in the memory that when executed, cause the processor to:
when performing the validation of the response:
determine whether the received response is aligned with retrieved facts of the context, based on the state of the AI-based conversational system;
determine whether the received response complies with predefined constraints of a domain of the text input; and
determine whether the received response is logically consistent.
